(19) United States
(12) Patent Application Publication
(10) Pub. No.: US 2025/0308330 A1
(43) Pub. Date: Oct. 2, 2025

(54) Electronic Game Systems and Methods with Multilevel Metamorphic Features

(71) Applicant: Aristocrat Technologies, Inc., Las Vegas, NV (US)

(72) Inventor: Erick Ching, Cedar Park, TX (US)

(21) Appl. No.: 19/090,913

(22) Filed: Mar. 26, 2025

Related U.S. Application Data
(60) Provisional application No. 63/571,234, filed on Mar. 28, 2024.

(51) Int. Cl. G07F 17/32; G06F 7/58

(52) U.S. Cl. CPC G07F 17/3267; G06F 7/588; G07F 17/3213

(57) ABSTRACT

An electronic gaming machine includes one or more processors and memory storing instructions that, when executed, cause the processors to perform operations. The operations include presenting a feature game comprising metamorphic feature game interface elements, each corresponding to a different feature game value. During the feature game, a feature game value is adjusted based on an output of a random number generator, and an appearance of a corresponding metamorphic interface element is adjusted. An outcome of the feature game is determined based on an additional output of the random number generator and the feature game values. A state of a base game is adjusted based on the outcome of the feature game. The feature game values may be incremented according to a sequence of levels, each corresponding to a different enhancement multiplier. The outcome may be determined using a Hold and Spin matrix with activated metamorphic enhancements applied to positions.

### RELATED APPLICATION(S)

The present application claims priority to U.S. Provisional Patent Application No. 63/571,234, filed Mar. 28, 2024, and entitled “Electronic Game Systems and Methods with Multilevel Metamorphic Features,” which is hereby incorporated by reference in its entirety.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Games sometimes use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### SUMMARY

In some aspects, the techniques described herein relate to an electronic game machine including one or more processors and memory readable by the one or more processors, the memory having stored thereon computer-executable instructions for causing the one or more processors, when executed thereby, to perform operations to control a user interface of an electronic gaming device, the operations including: presenting a feature game including metamorphic feature game interface elements, each metamorphic interface element corresponding to a different feature game value in a plurality of feature game values by incrementing the feature game value according to a sequence of levels, wherein each level corresponds to a different enhancement multiplier, during the feature game, adjusting: based on an output of a random number generator, a feature game value included in the plurality of feature game values and an appearance of a corresponding feature game metamorphic interface element to represent the incremented feature game value, determining, during the feature game, based on an additional output of the random number generator and the plurality of feature game values, an outcome of the feature game by: generating a n×m Hold and Spin (HnS) matrix, where n and m are integers greater than 1, applying activated metamorphic enhancements to positions in the n×m HnS matrix, and determining winning combinations in the n×m HnS matrix based on the applied metamorphic enhancements and the additional output of the random number generator, and adjusting a state of a base game based on the outcome of the feature game.

In some aspects, the techniques described herein relate to an electronic game machine, wherein each metamorphic feature game interface element corresponds to a different feature game value by incrementing the feature game value according to a sequence of levels, wherein each level corresponds to a different enhancement multiplier.

In some aspects, the techniques described herein relate to an electronic game machine, wherein the operations further include presenting a base game including a plurality of persistent metamorphic features, each persistent metamorphic feature corresponding to a column in an i×j feature game matrix, where i and j are integers greater than 1.

In some aspects, the techniques described herein relate to an electronic game machine, wherein the operations further include, during the base game, incrementing a persistent metamorphic feature based on landing of trigger symbols in the base game.

In some aspects, the techniques described herein relate to an electronic game machine, wherein the operations further include activating a metamorphic feature enhancement by projecting triggered symbols into a corresponding column of the ixj feature game matrix.

In some aspects, the techniques described herein relate to an electronic game machine, wherein adjusting the state of the base game includes randomly distributing coins from the feature game onto a base game matrix to provide a head start for a subsequent trigger of a metamorphic feature in the base game.

In some aspects, the techniques described herein relate to an electronic game machine, wherein: each metamorphic interface element includes a progression state indicative of non-triggered feature game values, where the operations further include adjusting the feature game value of a triggered metamorphic interface element based on the progression states of non-triggered metamorphic interface elements, where the adjustment of the triggered feature game value includes introducing auxiliary bonuses or enhancements to the n×m Hold and Spin (HnS) matrix, wherein the auxiliary bonuses or enhancements are applied to selected positions within the n×m HnS matrix based on the progression states of said non-triggered metamorphic interface elements.

In some aspects, the techniques described herein relate to a method including: presenting, via a user interface of an electronic game machine, a feature game including a plurality of metamorphic feature game interface elements, each metamorphic interface element corresponding to a different feature game value in a plurality of feature game values, during the feature game, adjusting, based on an output of a random number generator: a feature game value included in the plurality of feature game values, and an appearance of a corresponding feature game metamorphic interface element, determining, based on an additional output of the random number generator and the plurality of feature game values, an outcome of the feature game, and adjusting a state of a base game based on the outcome of the feature game.

In some aspects, the techniques described herein relate to a method, wherein each metamorphic feature game interface element corresponds to a different feature game value by incrementing the feature game value according to a sequence of levels, wherein each level corresponds to a different enhancement multiplier.

In some aspects, the techniques described herein relate to a method, wherein determining the outcome of the feature game includes: generating a n×m Hold and Spin (HnS) matrix, where n and m are integers greater than 1, applying activated metamorphic enhancements to positions in the n×m HnS matrix, and determining winning combinations in the n×m HnS matrix based on the applied metamorphic enhancements and the additional output of the random number generator.

In some aspects, the techniques described herein relate to a method, further including presenting a base game including a plurality of persistent metamorphic features, each persistent metamorphic feature corresponding to a column in an i×j feature game matrix, where i and j are integers greater than 1.

In some aspects, the techniques described herein relate to a method, further including during the base game, incrementing a persistent metamorphic feature based on landing of trigger symbols in the base game.

In some aspects, the techniques described herein relate to a method, further including activating a metamorphic feature enhancement by projecting triggered symbols into a corresponding column of the i×j feature game matrix.

In some aspects, the techniques described herein relate to a method, wherein adjusting the state of the base game includes randomly distributing coins from the feature game onto a base game matrix to provide a head start for a subsequent trigger of a metamorphic feature in the base game.

In some aspects, the techniques described herein relate to a non-transitory computer-readable storage medium having computer-executable instructions embodied thereon, wherein, when executed by one or more processors of an electronic game machine, the computer-executable instructions cause the one or more processors to: present a feature game including a plurality of metamorphic feature game interface elements, each metamorphic interface element corresponding to a different feature game value in a plurality of feature game values, during the feature game, adjust, based on an output of a random number generator: a feature game value included in the plurality of feature game values, and an appearance of a corresponding feature game metamorphic interface element, determine, based on an additional output of the random number generator and the plurality of feature game values, an outcome of the feature game, and adjust a state of a base game based on the outcome of the feature game.

In some aspects, the techniques described herein relate to a non-transitory computer-readable storage medium, wherein each metamorphic feature game interface element corresponds to a different feature game value by incrementing the feature game value according to a sequence of levels, wherein each level corresponds to a different enhancement multiplier.

In some aspects, the techniques described herein relate to a non-transitory computer-readable storage medium, wherein the computer-executable instructions further cause the one or more processors to: generate a n×m Hold and Spin (HnS) matrix, where n and m are integers greater than 1, apply activated metamorphic enhancements to positions in the n×m HnS matrix, and determine winning combinations in the n×m HnS matrix based on the applied metamorphic enhancements and the additional output of the random number generator.

In some aspects, the techniques described herein relate to a non-transitory computer-readable storage medium, wherein the computer-executable instructions further cause the one or more processors to present a base game including a plurality of persistent metamorphic features, each persistent metamorphic feature corresponding to a column in an i×j feature game matrix, where i and j are integers greater than 1.

In some aspects, the techniques described herein relate to a non-transitory computer-readable storage medium, wherein the computer-executable instructions further cause the one or more processors to, during the base game, increment a persistent metamorphic feature based on landing of trigger symbols in the base game.

In some aspects, the techniques described herein relate to a non-transitory computer-readable storage medium, wherein adjusting the state of the base game includes randomly distributing coins from the feature game onto a base game matrix to provide a head start for a subsequent trigger of a metamorphic feature in the base game.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates a schematic representation of operations within an electronic gaming machine incorporating multi-level persistent metamorphic features as described herein.

FIG. 5 illustrates an alternative schematic representation of operations within an electronic gaming machine incorporating multi-level persistent metamorphic features as described herein.

FIG. 6 illustrates a flowchart of a representation of operations within an electronic gaming machine incorporating multi-level persistent metamorphic features as described herein.

### DETAILED DESCRIPTION

Electronic gaming devices, systems, and methods are described herein that provide multi-level persistent metamorphic features. These features can be incremented or enhanced during gameplay and have the potential to be triggered to provide an added layer of excitement and strategy. Furthermore, non-triggered metamorphics may offer players a strategic advantage in subsequent stages of the game, enhancing player engagement. Still further, these EGMs and systems may be configured to designate or control the degree of randomness in a pseudorandom gaming environment. This allows the systems to drive various metamorphic trigger mechanics in a manner that complies with regulatory guidelines while maintaining player engagement. Still further, these EGMs and systems address a prevalent challenge in the gaming industry concerning regulatory constraints on RTP. By enabling players to accumulate and utilize the persistence of non-triggered metamorphic features, these systems enhance player control while ensuring a specified overall RTP.

In some examples, embodiments of this disclosure may include an electronic wagering game with a combination of two game modes: a 4×5 matrix base game and a feature game. The feature game itself may include a 3×3 matrix and a 4×5 Hold and Spin (HnS) matrix. In the base game, there may be three (or more) persistent metamorphic features: Throw Cash-on-Reels (CORs), Multiply Frame, and Blast Zone. Each of these may correspond to a column on the 3×3 matrix in the feature game. When trigger symbols (e.g., coins) land on the base game, the corresponding metamorphic feature (e.g., a visual representation of a pot of coins) increases (e.g., in size, quantity, etc.).

Triggering a metamorphic feature may throw (i.e., transfer or otherwise display) the triggered symbols into the corresponding column of the 3×3 matrix, lock those symbol positions, and activate that metamorphic feature enhancement. If a metamorphic feature is not triggered, any coins collected for that feature may have a random chance of landing and locking in a position on the 3×3 matrix.

During the feature game, both the 3×3 matrix and the 4×5 matrix may spin concurrently, with the 3×3 matrix completing its spin first. Any unlocked symbols on the 3×3 matrix may spin during this time. If a trigger symbol lands in a column on the 3×3 matrix, it may lock and activate the corresponding metamorphic enhancement for the ongoing HnS spin on the 4×5 matrix. The 4×5 matrix may then complete its spin last. If all reel symbol positions of a column lock a triggering symbol, that metamorphic enhancement is activated for the remaining plays of the feature game.

The feature game may play out as a HnS of both the 3×3 feature matrix (i.e., to try to land additional triggering symbols and activate more metamorphic enhancements) and the 4×5 feature matrix HnS (to try to land additional CORs). Any activated metamorphic enhancements may be applied to the outcome of the 4×5 HnS.

Hence, embodiments of this disclosure may enable the player to use the accumulated persistence of non-triggered metamorphic features as a head-start or as an enhancement during the feature game. At the end of the feature game, coins may “fly out” and give the player a chance to retrigger the feature or give the player a head start toward the next base game trigger of the metamorphic feature.

Moreover, in some embodiments, the disclosed systems and methods may also incorporate levels of metamorphics, where the greater the level of the metamorphic, the greater the enhancement. For example, coins landing in the metamorphic may increment the metamorphic toward triggering, but if a “special” coin lands in the metamorphic, the value of the metamorphic may also increase (e.g., a metamorphic award multiplier enhancement might increase from 2× to 3× to 4×, etc.), and may be applied to the feature if that metamorphic triggers. The levels of the metamorphics may also randomly vary during each spin of the feature.

In some embodiments, the disclosed systems and methods may also incorporate a multi-level metamorphic feature mechanism, wherein the progression states of non-triggered features directly influence the game dynamics of a triggered feature. This design may augment traditional metamorphic systems by adding strategic depth and enhancing player engagement.

By way of illustration, an example system may employ a plurality of metamorphic features, each with a predefined set of progression states ranging from an initial state to a fully triggered state. Each feature may undergo incremental progressions based on gameplay actions or outcomes, visually represented on the game interface to indicate its development extent.

Upon entry into a selected feature—deemed the “triggered metamorphic feature”—the system dynamically assesses the progression states of all non-triggered metamorphic features within the gaming session. The partial or complete progress of these metamorphic features substantively influences the initiated session of the triggered metamorphic feature.

For instance, the triggered metamorphic feature may begin with modified parameters, where the progression states or levels of other features contribute qualitative or quantitative modifications. Such modifications may include, but are not limited to, increases in available bonuses, enhanced probabilities of favorable outcomes, or integration of auxiliary gameplay elements derived from the non-triggered features.

Consider a gaming scenario involving three distinct features: Feature A, Feature B, and Feature C. If Feature A is triggered while Feature B and C have attained intermediate progression states, their progression results in seeding additional activation symbols or bonuses within Feature A's gameplay, thereby modifying the player's experience within that session.

If Feature B has reached a mid-level state, the system may integrate auxiliary bonuses into Feature A, effectively increasing available multipliers or unlocking certain game enhancements. Similarly, partial progression of Feature C may introduce special game conditions, such as increased probability modifiers, applied to Feature A's active play state.

Embodiments of this disclosure may enhance electronic gaming machine functions and game design technology by introducing a unique mechanism of persistent metamorphic features that add a new layer of strategy and excitement to slot games. The innovative combination of a base game and a feature game with different matrix configurations, along with the HnS feature, offers players a more dynamic and engaging gaming experience. The present disclosure also addresses a common challenge in the gaming industry related to regulatory constraints such as RTP. By providing players with the ability to accumulate and use the persistence of non-triggered metamorphic features as a head-start in the feature game, it enhances the perception of player control and potentially increases the overall RTP, while still adhering to regulatory requirements.

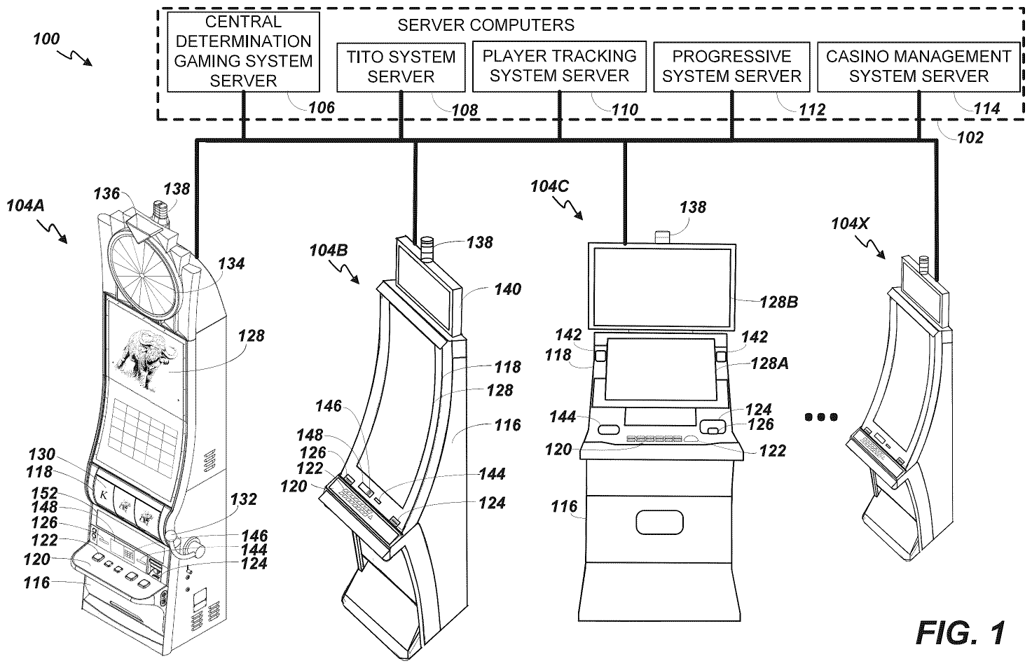

This inventive approach thus solves a critical problem in game design, offering a more enjoyable gaming experience that also complies with regulatory standards. Moreover, the embodiments herein may be designed to maintain an RTP that is high enough to provide an enjoyable experience to the player, while also providing a product that is profitable and can be used in the long run. Still further, as noted above, the embodiments herein may implement different levels or degrees of randomness within the base game and/or the feature game. These embodiments may control the degree of randomness in a pseudo random environment to drive the various trigger mechanics in a manner that complies with regulatory guidelines. These embodiments will be described further below with regard to FIGS. 1-6.

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XLTM model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

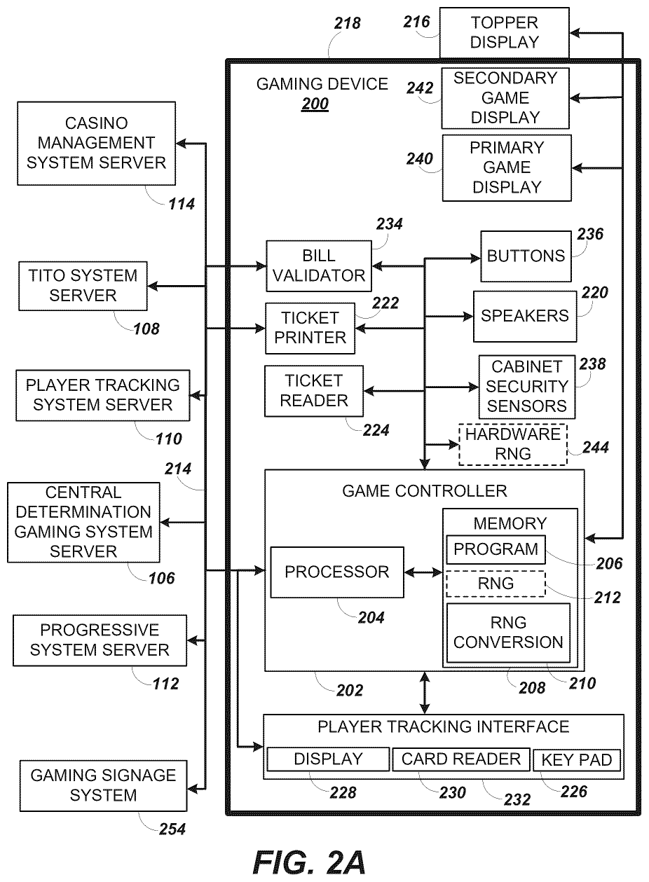

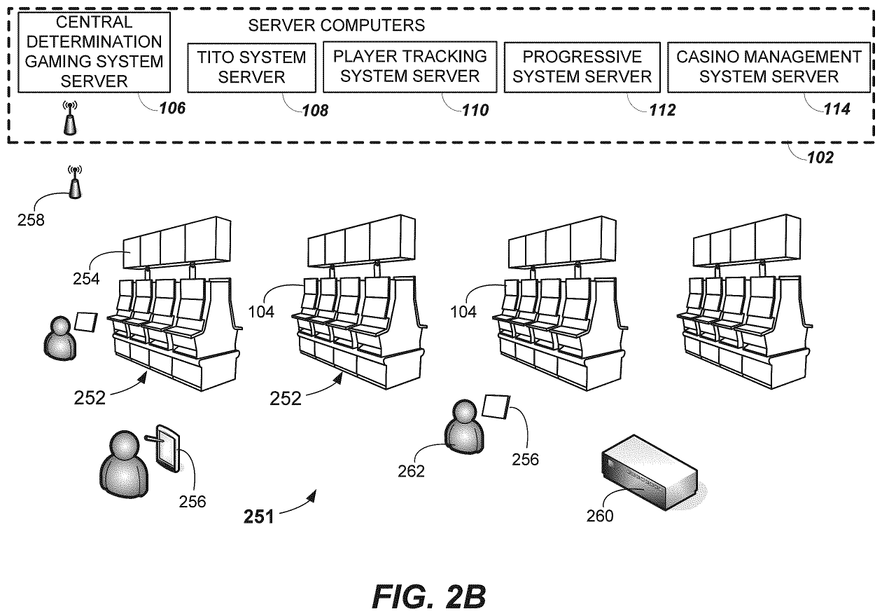

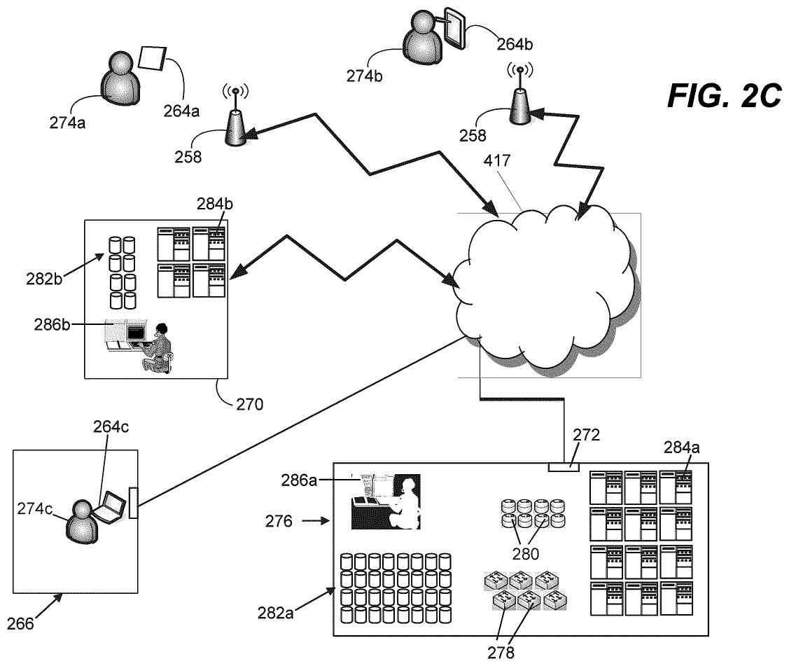

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the ArcTM model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the HelixTM model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264a-c and/or other information regarding authorized users of EUDs 264a-c (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264a-c or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

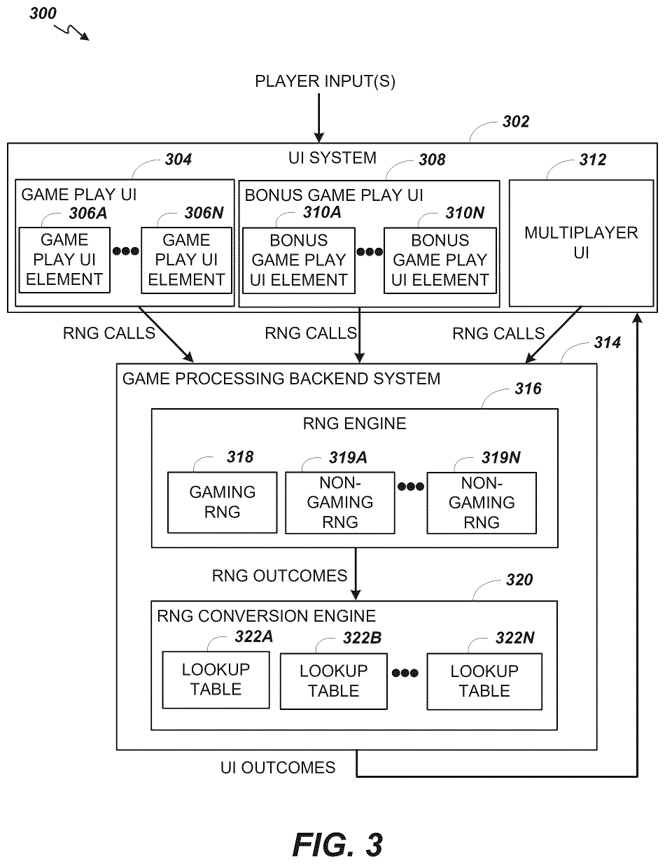

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or present game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could correspond to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

As described above, some embodiments of this disclosure include mechanisms for presenting a unique electronic wagering game that intertwines two distinct game modes: a n×m (row×column) matrix base game and a feature game, which includes a i×j (row×column) matrix and a n×m (row×column) HnS matrix. UI system 302 may present, within the base game, a number of persistent metamorphic features. In some examples, these features can include Throw CORs, Multiply Frame, and Blast Zone (i.e., a “blast” may result in an instant payout of any CORs in a specific “Blast Zone”), though this disclosure is not limited to these specific features, and some examples may incorporate different and/or additional features. Each feature may relate to a column in the i×j feature game matrix. The landing of trigger symbols, such as coins, within the base game augments the corresponding metamorphic feature.

At least in some cases, the activation of a metamorphic feature results in the triggered symbols being projected into the respective column of the i×j matrix, thus solidifying the symbol positions and triggering the metamorphic feature enhancement. Unlike other wagering games, the untriggered metamorphic features retain the potential to land and lock trigger symbols on the i×j matrix in a randomized fashion.

The feature game unfolds as a HnS of both the i×j and n×m matrices, with the player striving to land additional triggering symbols and CORs, with any activated metamorphic enhancements influencing the n×m HnS outcome. Such an implementation may afford players the opportunity to leverage the accumulated persistence of non-triggered metamorphic features as an enhancement or as a head-start during the feature game. It also provides the thrill of a potential feature retriggering, or a head start on the next base game trigger of the metamorphic feature when the feature concludes and coins “fly out” to randomly land on the base game matrix.

Furthermore, varying levels of metamorphics are also incorporated, where a higher level of metamorphic equates to a greater enhancement. The introduction of “special” coins can also increment and increase the value of the metamorphic, which is then applied if that specific metamorphic then triggers. These levels can also fluctuate randomly with each spin of the feature.

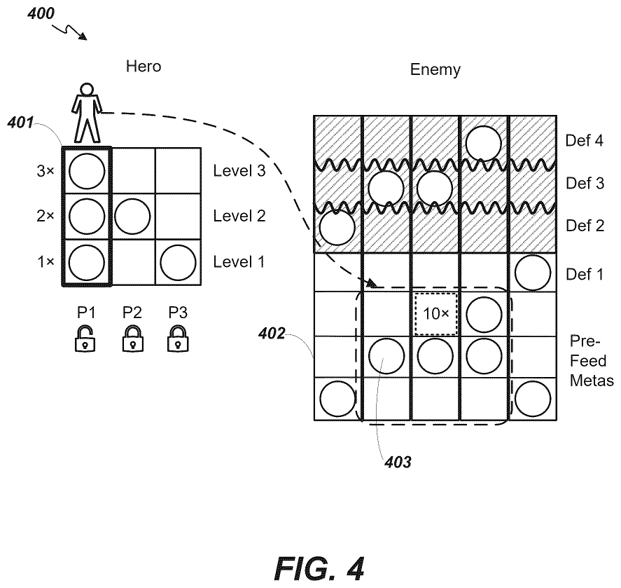

FIG. 4 illustrates a schematic representation 400 of operations within an electronic gaming machine incorporating multi-level persistent metamorphic features as described herein. UI system 302 may provide a player interface of a base game displaying a Hero side and an Enemy side, representing various stages and elements of gameplay that provide a unique gaming experience enhanced by the above-described multi-level persistent metamorphic features.

In the illustrated embodiment, the player interface presents an example configuration inclusive of a 3×3 feature matrix 401, which may be a non-restrictive example or illustration of an i×j feature matrix, where i=j. This feature matrix 401 may be divided into three columns (j) of three vertical positions, denoted as P1, P2, and P3, and three rows (i) of three horizontal positions corresponding to levels indicated as Level 1, Level 2, and Level 3. Each position and level may correspond to particular metamorphic features that are persistent and can be enhanced during gameplay.

For example, in one embodiment, the 3×3 feature matrix 401 may interact with three persistent metamorphic features (although more or fewer metamorphic features may be used within the base game). These features may represent Throw Cash-on-Reels (CORs) for P1, Multiply Frame for P2, and Blast Zone for P3. The icons may be metamorphics that visually increase in size, indicating the enhancement of the respective feature. Moreover, the metamorphics P1-P3 may be tied to a corresponding column in the feature game matrix 401.

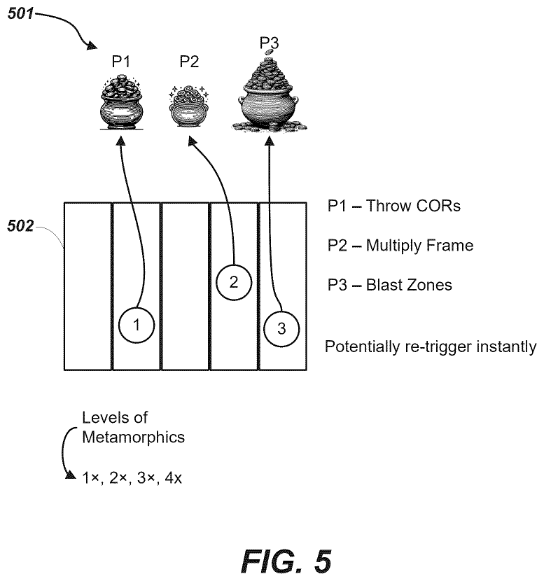

For example, an increase in the collected coins may be represented by a visual increase in the icon's size corresponding to the pot of coins. FIG. 5, for example, illustrates an embodiment where “pot-of-gold” icons 501 can increase in size as coins (or other items) are collected. In this embodiment, the Throw Cash-on-Reels bonus feature (corresponding to P1) may increase in value over time as triggering symbols are hit within the base game. The pot of gold metamorphic P1 may, thus, grow in the number of coins (although the growth in size or in the number of coins may not be commensurate with the growing value of the bonus feature). If that feature fully triggers, the Throw Cash-on-Reels bonus feature may be added to a separate n×m HnS matrix (402), where additional COR symbols may be added during gameplay.

At least in some cases, other bonus features associated with metamorphics P2 and P3 that are part of matrix 502 may also be at least partially applied during gameplay, based on how many P2 and/or P3 trigger symbols have landed and how those metamorphics have grown in value. In such cases, if P1 fully triggers, P2 Multiply Frame may partially trigger, allowing at least some multiples (e.g., a 10× multiplier) within the separate HnS matrix 402. Additionally or alternatively, the P3 bonus feature may be at least partially applied during gameplay, potentially increasing the size of a blast zone that provides prizes of increased value. Again, this feature may be fully or partially enabled based on the current value or collection total of the corresponding P3 metamorphic. In this manner, full or partial metamorphic bonus features may be applied according to the current value or collection total of each metamorphic (resulting in that metamorphic being fully or partially triggered).

During the feature game, the 3×3 matrix 401 may serve as a dynamic component where any unlocked symbols can spin independently. Upon the landing of a trigger symbol in a column, the column becomes locked, and the related metamorphic enhancement is activated for the next HnS turn within the feature game. At least in some cases, the feature game may be played out in a dual manner, utilizing both the i×j feature matrix 401 to attempt to activate additional metamorphic enhancements and a separate n×m (in this example, 4×5) HnS matrix to attempt to land additional CORs. Any activated metamorphic enhancements (e.g., Throw CORs, Multiply Frame, Blast Zone, etc.) may influence the outcomes on the n×m HnS matrix 401. This influence on reel strip outcomes may include applying accumulated features and increasing the potential for a specific result.

In at least some cases, these COR values and metamorphic enhancements may be generated in response to a specific technical problem. For instance, the embodiments described herein may address many different technical problems including at least one of: (i) an inability of known systems to provide certain symbol positions that cause symbols to persist and certain symbol positions that do not cause symbols to persist; (ii) an inability of known systems to cause certain COR symbols to persist and the values associated therewith to be applied across multiple spins while controlling RTP; (iii) an inability of known systems to efficiently communicate which symbols persist and which symbols do not persist; and (iv) an inability of known systems to dynamically select a bonus feature presentation from a plurality of presentations stored in memory based at least in part upon a total win amount or on a set of triggering symbols that would trigger a feature game.

The resulting technical effects and/or technical benefits achieved by this disclosure include at least one of: (i) an ability to provide certain symbol positions that cause symbols to persist and certain symbol positions that do not cause symbols to persist; (ii) an ability to cause certain COR symbols to persist and the values associated therewith to be applied across multiple spins while controlling RTP; (iii) an ability to efficiently communicate which symbols persist and which symbols do not persist; (iv) an ability to dynamically select a bonus feature presentation from a plurality of presentations stored in memory based at least in part upon a total win amount or based upon a certain level (e.g., Level 3) being achieved; (v) displaying large quantities of complex information in a relatively small display area; (vi) communicating complex information with easy-to-understand animations on a display; (vii) efficiently communicating different game rules on a display during game play; and (ix) providing versatility as to which devices (e.g., EGMs, mobile devices, etc.) the games described herein may be played on because of the efficient display area designs described herein.

Various interface improvements are provided herein to efficiently and effectively communicate information. For instance, during play of the bonus feature, as described herein, various animations are provided to communicate which symbol positions and metamorphic triggers will initiate the bonus feature. During the game, COR symbols may be illuminated during play of the bonus feature while the reels may be dimmed out in order to communicate that values associated with the COR symbols are eligible to be provided and that payline evaluations of symbols on the reels may not occur. Moreover, metamorphic symbols may be dynamically updated to indicate a general level of progression, although changes in the metamorphic may not be linearly tied to progression within the game.

Example embodiments described herein may be provided in combination or in isolation to summarize and present game mechanics in a manner that improves the efficiency of computer systems (e.g., electronic gaming systems including electronic gaming devices). Each example system provides an improved user interface displaying a limited set of information to players, potentially within a small screen, such that players can more quickly understand the current status of the game. The systems and methods provide improved display device functionality (e.g., on a gaming device) by providing multiple visual indicators that communicate game mechanics described herein to players. The systems and methods provided herein also improve display and device efficiency by eliminating the need for complex information pages describing game mechanics to players. Because of at least the easily-understood animations, symbols, and indicators displayed, the games described herein can be played and understood on a single screen substantially smaller than some of the EGMs described herein (e.g., a mobile device such as a cell phone), thus removing the need for multiple displays with complex information screens including lengthy text.

Further technical challenges arise when storing presentations (e.g., scripts of spins) for selection upon the bonus feature being triggered. For instance, in order to build presentations (e.g., facades), as explained herein, many game rounds are simulated and win amounts and display presentations are chosen for a presentation. For instance, a set of predetermined win amounts may be selected (e.g., based on desired RTP) and then presentations are generated to display these wins via the features available in the game (e.g., the base game, the bonus feature, etc.).

By generating and storing presentations for selection according to the various embodiments explained herein, computer efficiency is increased, and computer resources are saved at least because the presentations allow for fewer determinations to be made by a gaming device and/or server as the game is being played. Various presentations being stored for different metamorphics increases variability in how win amounts may be provided because, while different metamorphic levels may be provided during play of the game, the same win amount may be provided with different combinations of the base game and/or the bonus feature.

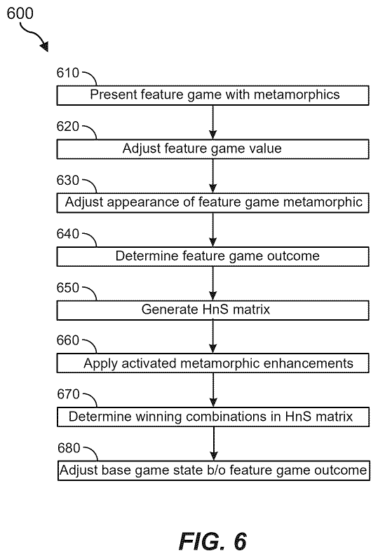

One embodiment introduces metamorphic levels that increment the value of each metamorphic feature. Coins, or special coins, that land within a metamorphic feature may increment towards triggering and enhancing the metamorphic value. This increase may be from a 2× level to a 3× level and further to a 4× level (as shown in FIG. 5). As such, this process may exponentially increase the potential enhancement applied to the feature game upon triggering. Each metamorphic feature may be individually increased from 1× to 2× or 3× or 4× or more. This process will be described further below with regard to method 600 of FIG. 6.

At least some of the embodiments described herein, including method 600 of FIG. 6, may be carried out by an electronic game machine (EGM). Such an EGM may include one or more processors and memory readable by the one or more processors, the memory having stored thereon computer-executable instructions for causing the processors, when executed thereby, to perform operations to control a user interface of the EGM. The electronic gaming system may include a housing. The housing may be similar to or the same as cabinet 218 described above in conjunction with FIG. 2. The housing may provide structural support for an electronic display device that is mounted to the housing. The housing may also provide structural support for at least one input device using which a game player can provide inputs to the electronic gaming system. The input device may be a physical button or set of buttons that are pressed, alone or in conjunction, to provide game inputs. The input device may additionally or alternatively include a touchscreen display that provides input graphical display elements.

The electronic gaming system may also include a value input device and/or a value output device. The value input device may include a physical bill acceptor, a coin acceptor, or an electronic card reader configured to wirelessly or physically interface with a credit card, debit card, or stored value card that adds money or credits with which to wager. The value input device may be linked to monetary systems or databases that provide value to the electronic gaming system that can be used within the electronic wagering game. The value output device may similarly include a bill acceptor or bill output device or coin acceptor or output device that dispenses physical currency.

The value output device may also include an electronic card reader that wirelessly or physically interfaces with a credit card, debit card, stored value card, or digital wallet to apply money to that card or associated account or dispense payout of physical currency. Both the value input device and the value output device may be controlled by a controller of the electronic gaming system to receive value (physical currency or electronic currency) or return value (physical or electronic currency) to the user. The controller may cause the value input device or value output device to perform these functions upon receiving signals from the electronic wagering game indicating that currency debits or returns are to occur based on one or more in-game actions. For instance, the controller may be configured to detect, via the value input device, a physical item associated with a monetary value that establishes a monetary balance (e.g., a cash bill or a credit card). The controller may be further configured to receive, via the input device, a wager that is drawn from the monetary balance. At the conclusion of a game, the value output device, in response to a cashout input received via the input device, may dispense a payout from the monetary balance.

At least in some cases, the electronic gaming system may include a mobile electronic device (e.g., a smartphone, a tablet, a smartwatch, a laptop, or similar computing device). Such a mobile electronic device may include a housing that provides structural support for internal electronic components, including a controller, a value input device or value output device (e.g., a Bluetooth card reader or near-field communication (NFC) chip reader), or a touchscreen input device that a game player can use to provide inputs to the electronic gaming system.

The controller of the electronic gaming system may be further configured to perform a method for generating and providing fully enabled and partially enabled metamorphic features in electronic wagering games. This method is generally shown in FIG. 6. The steps shown in FIG. 6 may be performed by any suitable computer-executable code and/or computing system, including the electronic gaming machines illustrated in FIGS. 1-3.

In some examples, the steps shown in FIG. 6 may be performed by modules operating in an endpoint device such as an electronic gaming machine (EGM) (e.g., operating in a casino environment as described in connection with FIG. 1), or a personal user device (e.g., a smart phone, tablet, laptop, wearable device, and/or desktop), or by modules operating in a server (e.g., a backend computing device). In one example, each of the steps may represent an algorithm whose structure includes or is represented by multiple sub-steps, examples of which will be provided in greater detail below. In some examples, the steps may be executed by game processing backend system 314 as part of game processing architecture 300 as described in connection with FIG. 3.

The method 600 includes, at step 610, presenting a feature game comprising metamorphic feature game interface elements. Each metamorphic interface element may correspond to a different feature game value among a plurality of potential feature game values by incrementing the feature game value according to a sequence of levels. Each level may correspond to a different enhancement multiplier. Next, at steps 620 and 630, method 600 includes adjusting, during the feature game and based on an output of a random number generator, a feature game value included in the plurality of feature game values and adjusting an appearance of a corresponding feature game metamorphic interface element to represent the incremented feature game value.

At step 640, method 600 includes determining, during the feature game, based on an additional output of the random number generator and the plurality of feature game values, an outcome of the feature game by: generating a n×m Hold and Spin (HnS) matrix, where n and m are integers greater than 1 (step 650), applying activated metamorphic enhancements to positions in the n×m HnS matrix (step 660), determining winning combinations in the n×m HnS matrix based on the applied metamorphic enhancements and the additional output of the random number generator (step 670), and adjusting a state of a base game based on the outcome of the feature game (step 680). In this manner, the systems herein may present a separate feature HnS matrix 402, apply those metamorphic enhancements that were activated (either fully or partially) according to the other feature game matrix 401. These systems may then determine winning combinations in the separate HnS matrix 402 based on the applied metamorphic enhancements and based on additional RNG outputs, and then adjust the base game according to the determined winning combinations.

Within the feature game and/or within the base electronic wagering game, one or many different random numbers may be implemented to facilitate gameplay. At least in some cases where random numbers are generated and implemented within the electronic wagering game (e.g., using random number generator 212 and/or 244 of FIG. 2A), the systems herein may carefully control or change the amount of randomness for each spin and/or for each reel in the spin and/or for each symbol location in the spin to craft a specific outcome or range of outcomes. For example, in an n×m matrix, such as matrix 401 or matrix 402 of FIG. 4, each of the reels may have multiple different value-bearing symbols. Each time the user spins the reels, the specific value-bearing symbols for each of the (e.g., 9 or 20) locations in the array may be chosen based on a random number. In some cases, the degree of randomness may be the same for each reel or for each location within the array. In other cases, the degree or amount of randomness may be different for each reel or for each location in the array.

In some cases, for example, the degree of randomness for a given spin increases or decreases for each reel, from left to right. Thus, in some examples, the degree of randomness may start at a specified level (X) for the first reel on the left. For the second reel, the degree of randomness may decrease to X-Y, where Y is a numerical value above zero. For the third reel, the degree of randomness may decrease further to X-Y-Z, where Z is a numerical value above zero, and so on through the fifth or subsequent reels. In that case, each progressive reel would have a decreased level of randomness, thus making some outcomes more likely in each subsequent reel. In such embodiments, game designers may specify which outcomes are more likely to occur within the reduced parameters for randomness.

In other cases, the degree of randomness may start at a specified level (X) for the first reel on the left and may increase for each reel to the right. Thus, for the second reel, the degree of randomness may increase to X+Y, where Y is a numerical value above zero. For the third reel, the degree of randomness may increase further to X+Y+Z, where Z is a numerical value above zero, and so on through the fifth or subsequent reels. In such cases, each progressive reel would have an increased level of randomness, thus making some outcomes less likely in each subsequent reel. Accordingly, in these embodiments, game designers may specify which outcomes are less likely to occur within the increased parameters for randomness. In still further cases, some reels may have increased randomness, and some reels may have decreased randomness within the same spin. Moreover, in some cases, the randomness of each reel is independently determined for that reel and is not based on the results of any previous reels. In such cases, each reel value is randomly determined, independent of other reels.

Moreover, at least in some cases, the degree of randomness may change dynamically based on the previously selected random values. Thus, if certain value-bearing symbols appear in the first or second reels (e.g., CORs or metamorphic-triggering symbols), other value-bearing symbols may be more or less likely to appear in the third, fourth, fifth, or subsequent reels according to the dynamic changes in randomness. In this manner, the controller, either alone or in conjunction with the RNG, may carefully control the level or degree of randomness for each spin, and for each reel in that spin. The degree of randomness may provide parameters for the randomly selected values, ensuring that the randomness is above a specified value (X) but below a specified value (Y). These values may be predefined or may be established and changed dynamically over time as a particular game is played.

In some cases, for example, randomness may be controlled or bounded to increase the likelihood of CORs appearing on one or more of the reels. Or, the randomness may be controlled or bounded to increase the likelihood of wilds or metamorphic trigger symbols or scatter symbols appearing on one or more of the reels. Still further, randomness may be controlled to increase the likelihood of multipliers or wild multipliers (that multiply any line win that passes through the wild) appearing on one or more of the reels in an array, or increase the likelihood of three-of-a-kind wins, four-of-a-kind wins, five-of-a-kind wins, etc. Thus, at least in some embodiments, the degree or amount of randomness may be controlled to apply bounds within which the RNG operates. This control of the randomness used in the game may be managed and carried out by the game controller. The controlled randomness may then be used to select value-bearing symbols for each reel and, when sufficient scatter symbols are present or when a metamorphic has reached a peak level, a bonus gameplay mode may be provided in which previously locked arrays become available for play, leading to potentially higher winnings for the player and greater player satisfaction with the game.

At least in some embodiments, this controlled randomness may be implemented to randomly select symbols during a reel spin for any of the plurality of reel spins in an electronic wagering game (e.g., the base game and/or the group bonus game). In some cases, for example, the electronic wagering game may determine a gaming outcome (e.g., a set of matching symbols) by first selecting a reel set from multiple available reel sets (e.g., the far-left reel set in matrix 401 of FIG. 4). Each reel set may include unique reel strips that introduce a high probability of specific events occurring based on underlying weights associated with each reel set. Then, based on a random number generated by an RNG in a controlled randomness implementation, a first reel set may be selected from the plurality of reel sets, where each reel set includes multiple reel strips (e.g., 3 reel strips, 15 reel strips, etc.). Then, based on a random number for each reel, a reel spin outcome is selected. Each reel set of the various reel sets has a differing probability that a specific reel spin outcome will occur.

At least in some embodiments, as noted above, the base electronic wagering game provided by the electronic game machine may include multiple different metamorphic-triggering symbols. When those metamorphic-triggering symbols land in the base game, the corresponding metamorphics may be associated with enhancements in a feature game. Each metamorphic feature game interface element may correspond to or may dynamically change to a different feature game value by incrementing the feature game value according to a sequence of levels, where each level corresponds to a different enhancement multiplier. As different metamorphic-triggering symbols land, the corresponding enhancement multiplier for that metamorphic may increase from 1× to 2× or to 3×, and so on. In some cases, the metamorphic features may be persistent metamorphic features within the base game. In such cases, each persistent metamorphic feature may correspond to a column in the i×j feature game matrix (e.g., 401), where i and j are integers greater than 1.

During the base game, the electronic game machine may also increment a persistent metamorphic feature based on landing of metamorphic trigger symbols in the base game. Thus, if metamorphic trigger symbols land in matrix 401 of the feature game, for example, the EGM may also increment a persistent metamorphic feature in the feature game in matrix 402. Still further, the EGM may be configured to activate a metamorphic feature enhancement in the feature game by projecting triggered metamorphic symbols (in the base game) into a corresponding column of the i×j feature game matrix 402. At least in some cases, the state of the base game may then be adjusted based on the feature game matrix 402. This may include, for example, randomly distributing coins from the feature game onto the base game matrix 401 to provide a head start or an increased likelihood of a subsequent trigger of a metamorphic feature in the base game. Thus, as users land additional trigger symbols in the feature matrix 402, the EGM may randomly distribute coins from the feature game or provide other enhancements to the base game to increase the likelihood of landing subsequent metamorphic trigger symbols.

In some embodiments, each metamorphic feature element may have a progression state indicative of non-triggered feature game values. This progression state may be illustrated in matrix 401, where the column on the left has reached level 3 (e.g., fully triggered and fully unlocked, where all three levels of collection toward the metamorphic are complete), the column in the middle has reached level 2 (e.g., partially triggered and partially unlocked, where two levels of collection toward that metamorphic are complete), and the column on the right has reached level 1 (partially triggered and partially unlocked, where one level of collection for the corresponding metamorphic is complete). A triggered metamorphic interface element (e.g., 403) may be adjusted so that the feature game value of that triggered metamorphic interface element corresponds to or is based on the progression states of non-triggered metamorphic interface elements (e.g., corresponding to non-triggered elements P2 and P3).

The adjustment of the triggered feature game value may include introducing auxiliary bonuses or enhancements to the n×m HnS matrix 402. These auxiliary bonuses or enhancements may be applied to selected positions within the n×m HnS matrix 402 based on the progression states of the non-triggered metamorphic interface elements. Thus, even in scenarios where the P2 and P3 metamorphic interface elements have not been fully triggered (like P1 has), at least some portion of the auxiliary bonuses or enhancements associated with these metamorphics may be applied to the feature game. At least in some cases, the metamorphic enhancements to the feature game may be persistent upgrades that apply to future spins within the feature game (e.g., 10× prizes) until the gaming session is complete. Furthermore, as metamorphic trigger symbols land in the feature game, further levels or multipliers may be added back to the base game, making it more likely that additional metamorphic trigger symbols will land in the base game (e.g., in matrix 401).

This disclosure thus enhances electronic gaming machine functions and game design technology by introducing a unique mechanism of persistent metamorphic features, adding a new layer of strategy and excitement to slot games. It also provides systems for controlling the degree of randomness in a pseudorandom gaming environment to drive various metamorphic trigger mechanics in a manner that complies with regulatory guidelines. Still further, the systems herein address a prevalent challenge in the gaming industry concerning regulatory constraints on RTP. By enabling players to accumulate and utilize the persistence of non-triggered metamorphic features, these systems enhance player control while maintaining a specified overall RTP.

In some examples, one or more of the devices and/or subsystems may be employed in any number of software, firmware, and/or hardware configurations. For example, one or more of the embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-executable and/or computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program may be loaded into one of the devices and/or subsystems. All or a portion of the computer program stored on the computer-readable medium is then stored in memory and/or a storage device. When executed by a physical processor, a computer program loaded into the memory causes the physical processor to perform and/or be a means for performing the functions of one or more of the embodiments described and/or illustrated herein. Additionally or alternatively, one or more of the embodiments described and/or illustrated herein are implemented in firmware and/or hardware. For example, one or more of the devices and/or subsystems herein may be configured as an ASIC adapted to implement one or more of the embodiments disclosed herein.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. An electronic game machine comprising one or more processors and memory readable by the one or more processors, the memory having stored thereon computer-executable instructions for causing the one or more processors, when executed thereby, to perform operations to control a user interface of an electronic gaming device, the operations comprising:
presenting a feature game comprising metamorphic feature game interface elements, each metamorphic interface element corresponding to a different feature game value in a plurality of feature game values by incrementing the feature game value according to a sequence of levels, wherein each level corresponds to a different enhancement multiplier;
during the feature game, adjusting:
based on an output of a random number generator, a feature game value included in the plurality of feature game values; and
an appearance of a corresponding feature game metamorphic interface element to represent the incremented feature game value; and
determining, during the feature game, based on an additional output of the random number generator and the plurality of feature game values, an outcome of the feature game by:
generating a n×m Hold and Spin (HnS) matrix, where n and m are integers greater than 1;
applying activated metamorphic enhancements to positions in the n×m HnS matrix;
determining winning combinations in the n×m HnS matrix based on the applied metamorphic enhancements and the additional output of the random number generator; and
adjusting a state of a base game based on the outcome of the feature game.

2. The electronic game machine of claim 1, wherein each metamorphic feature game interface element corresponds to a different feature game value by incrementing the feature game value according to a sequence of levels, wherein each level corresponds to a different enhancement multiplier.

3. The electronic game machine of claim 2, wherein the operations further comprise presenting a base game comprising a plurality of persistent metamorphic features, each persistent metamorphic feature corresponding to a column in an i×j feature game matrix, where i and j are integers greater than 1.

4. The electronic game machine of claim 3, wherein the operations further comprise, during the base game, incrementing a persistent metamorphic feature based on landing of trigger symbols in the base game.

5. The electronic game machine of claim 4, wherein the operations further comprise activating a metamorphic feature enhancement by projecting triggered symbols into a corresponding column of the i×j feature game matrix.

6. The electronic game machine of claim 5, wherein adjusting the state of the base game comprises randomly distributing coins from the feature game onto a base game matrix to provide a head start for a subsequent trigger of a metamorphic feature in the base game.

7. The electronic game machine of claim 1, wherein:
each metamorphic interface element comprises a progression state indicative of non-triggered feature game values;
the operations further comprise adjusting the feature game value of a triggered metamorphic interface element based on the progression states of non-triggered metamorphic interface elements;
the adjustment of the triggered feature game value comprises introducing auxiliary bonuses or enhancements to the n×m Hold and Spin (HnS) matrix, wherein the auxiliary bonuses or enhancements are applied to selected positions within the n×m HnS matrix based on the progression states of said non-triggered metamorphic interface elements.

8. A method comprising:
presenting, via a user interface of an electronic game machine, a feature game comprising a plurality of metamorphic feature game interface elements, each metamorphic interface element corresponding to a different feature game value in a plurality of feature game values;
during the feature game, adjusting, based on an output of a random number generator:
a feature game value included in the plurality of feature game values, and
an appearance of a corresponding feature game metamorphic interface element;
determining, based on an additional output of the random number generator and the plurality of feature game values, an outcome of the feature game; and
adjusting a state of a base game based on the outcome of the feature game.

9. The method of claim 8, wherein each metamorphic feature game interface element corresponds to a different feature game value by incrementing the feature game value according to a sequence of levels, wherein each level corresponds to a different enhancement multiplier.

10. The method of claim 9, wherein determining the outcome of the feature game comprises:
generating a n×m Hold and Spin (HnS) matrix, where n and m are integers greater than 1;
applying activated metamorphic enhancements to positions in the n×m HnS matrix; and
determining winning combinations in the n×m HnS matrix based on the applied metamorphic enhancements and the additional output of the random number generator.

11. The method of claim 10, further comprising presenting a base game comprising a plurality of persistent metamorphic features, each persistent metamorphic feature corresponding to a column in an i×j feature game matrix, where i and j are integers greater than 1.

12. The method of claim 11, further comprising during the base game, incrementing a persistent metamorphic feature based on landing of trigger symbols in the base game.

13. The method of claim 12, further comprising activating a metamorphic feature enhancement by projecting triggered symbols into a corresponding column of the i×j feature game matrix.

14. The method of claim 13, wherein adjusting the state of the base game comprises randomly distributing coins from the feature game onto a base game matrix to provide a head start for a subsequent trigger of a metamorphic feature in the base game.

15. A non-transitory computer-readable storage medium having computer-executable instructions embodied thereon, wherein, when executed by one or more processors of an electronic game machine, the computer-executable instructions cause the one or more processors to:
present a feature game comprising a plurality of metamorphic feature game interface elements, each metamorphic interface element corresponding to a different feature game value in a plurality of feature game values;
during the feature game, adjust, based on an output of a random number generator:
a feature game value included in the plurality of feature game values, and
an appearance of a corresponding feature game metamorphic interface element;
determine, based on an additional output of the random number generator and the plurality of feature game values, an outcome of the feature game; and
adjust a state of a base game based on the outcome of the feature game.

16. The non-transitory computer-readable storage medium of claim 15, wherein each metamorphic feature game interface element corresponds to a different feature game value by incrementing the feature game value according to a sequence of levels, wherein each level corresponds to a different enhancement multiplier.

17. The non-transitory computer-readable storage medium of claim 16, wherein the computer-executable instructions further cause the one or more processors to:
generate a n×m Hold and Spin (HnS) matrix, where n and m are integers greater than 1;
apply activated metamorphic enhancements to positions in the n×m HnS matrix; and
determine winning combinations in the n×m HnS matrix based on the applied metamorphic enhancements and the additional output of the random number generator.

18. The non-transitory computer-readable storage medium of claim 17, wherein the computer-executable instructions further cause the one or more processors to present a base game comprising a plurality of persistent metamorphic features, each persistent metamorphic feature corresponding to a column in an i×j feature game matrix, where i and j are integers greater than 1.

19. The non-transitory computer-readable storage medium of claim 18, wherein the computer-executable instructions further cause the one or more processors to, during the base game, increment a persistent metamorphic feature based on landing of trigger symbols in the base game.

20. The non-transitory computer-readable storage medium of claim 19, wherein adjusting the state of the base game comprises randomly distributing coins from the feature game onto a base game matrix to provide a head start for a subsequent trigger of a metamorphic feature in the base game.
